(19) United States
(12) Patent Application Publication
(10) Pub. No.: US 2007/0297032 A1
(43) Pub. Date: Dec. 27, 2007

(54) HOLOGRAPHIC STORAGE SYSTEM WITH SINGLE SWITCH ACCESS

(75) Inventors: Tim Harvey, Fairfax, VA (US); Don Schmadel, College Park, MD (US)

Correspondence Address: HOWISON & ARNOTT, L.L.P, P.O. BOX 741715, DALLAS, TX, 75374-1715, US

(73) Assignee: STARZENT, INC., FAIRFAX, VA (US)

(21) Appl. No.: 11/750,264

(22) Filed: May 17, 2007

Related U.S. Application Data
(60) Provisional application No. 60/747,518, filed on May 17, 2006.

(51) Int. Cl. G03H 1/26

(52) U.S. Cl. 359/22

(57) ABSTRACT

A holographic data storage system utilizing optic switches. The data storage system includes a holographic data storage media adapted to receive a data beam and a reference beam and store a data pattern associated with the data beam. The stored data pattern is expressed by a holographic representation corresponding to data elements of the data beam.

### CROSS-REFERENCE TO RELATED APPLICATION

This application claims the benefit of priority from U.S. Provisional Application Ser. No. 60/747,518, filed May 17, 2006 and entitled HOLOGRAPHIC STORAGE SYSTEM WITH SINGLE SWITCH ACCESS (Atty. Dkt. No. STRZ-27,681). This application is related to co-pending U.S. application Ser. No. 11/251,574, filed Oct. 14, 2005, and entitled USES OF WAVE GUIDED MINIATURE HOLOGRAPHIC SYSTEM (Atty. Dkt. No. STRZ-27,372); U.S. application Ser. No. 11/251,576, filed Oct. 14, 2005, and entitled MINIATURE GUIDED WAVELENGTH MULTIPLEXED HOLOGRAPHIC STORAGE SYSTEM (Atty. Dkt. No. STRZ-27,373); and U.S. application Ser. No. 11/251,575, filed Oct. 14, 2005, and entitled BRANCH PHOTOCYCLE TECHNIQUE FOR HOLOGRAPHIC RECORDING IN BACTERIORHODOPSIN, the specifications of which are incorporated herein by reference.

### TECHNICAL FIELD OF THE INVENTION

This invention is related to data storage medium in general, and, more particularly, to holographic data storage.

### BACKGROUND OF THE INVENTION

Traditional storage media such as magnetic media are typically two-dimensional (2D) in scope. Holographic storage media is a three-dimensional (3D) recording technology and therefore offers greater storage densities than traditional 2D media. Typically, holographic media recording and information systems use angle encoding to multiplex different recorded data images or pages. This requires beam deflection, which then requires a non trivial standoff distance from the beam source. The resulting systems may have large form factors. Moreover the beam deflection typically requires moving that may be prone to failure, such as galvanometers.

### SUMMARY OF THE INVENTION

The present invention disclosed and claimed herein, in one aspect thereof, comprises a holographic data storage system. The data storage system includes a holographic data storage media adapted to receive a data beam and a reference beam, and store a data pattern associated with the data beam. The stored data pattern is expressed by a holographic representation corresponding to data elements of the data beam.

### BRIEF DESCRIPTION OF THE DRAWINGS

For a more complete understanding of the present invention and the advantages thereof, reference is now made to the following description taken in conjunction with the accompanying drawings in which:

FIG. 1 is a schematic illustration of a configuration of a holographic data storage system in accordance with principles of the present disclosure;

FIG. 2 is a schematic illustration of an optical switch structure for use in a holographic memory system;

FIG. 3 is a schematic illustration of an oblique view of a holographic storage medium;

FIG. 4 is a schematic illustration of another configuration of a holographic data storage system;

FIG. 5 is a schematic illustration of another configuration of a holographic data storage system;

FIG. 6 is a schematic illustration of another configuration of a holographic data storage system; and

FIG. 7 is a schematic illustration of a combined spatial light modulator (SLM) and imager.

### DETAILED DESCRIPTION OF THE INVENTION

Coherence and Planewave

The figures are not necessarily drawn to scale, and in some instances the drawings have been exaggerated and/or simplified in places for illustrative purposes only. One of ordinary skill in the art will appreciate the many possible applications, variations, and embodiments of the present system and device based on the following examples of various possible embodiments.

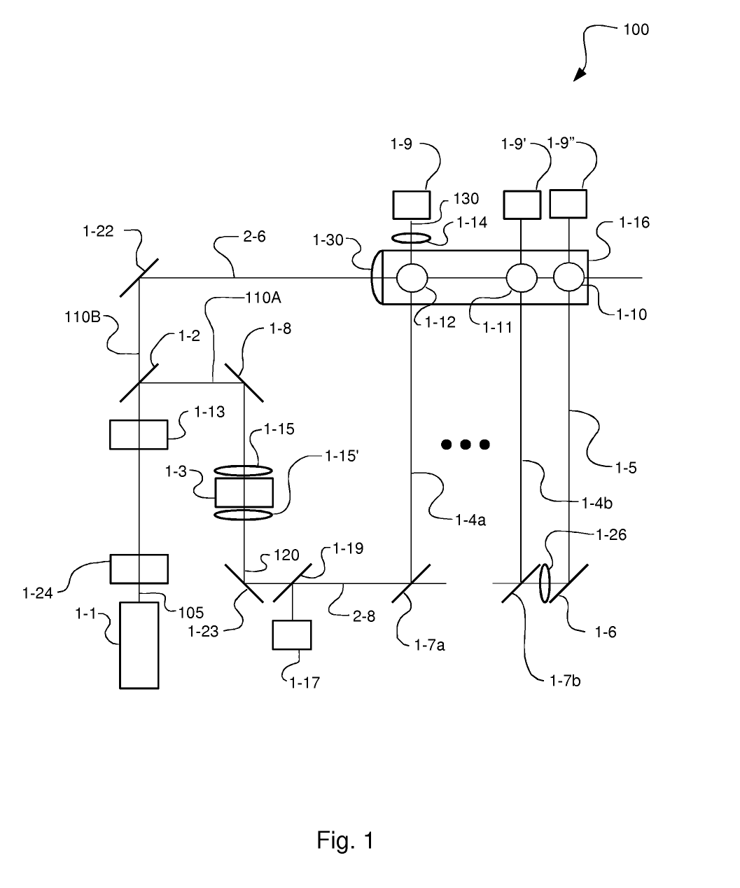

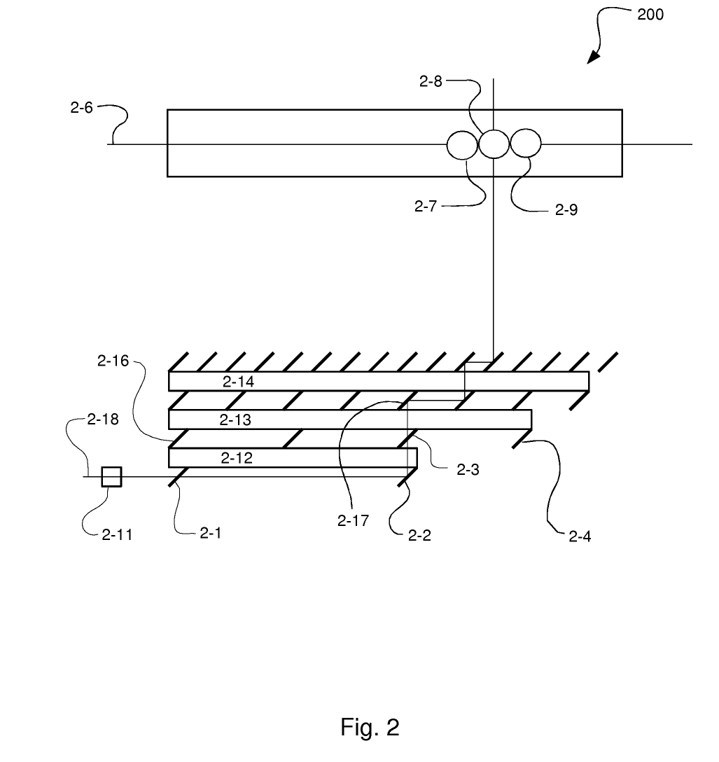

FIG. 1 is a schematic illustration of a configuration 100 of a holographic data storage system. The particular record and read geometry used for storing and retrieval respectively, is termed forward image. During recording, a laser 1-1 directs laser light, or a laser beam 105 to a beamsplitter 1-2. The laser 1-1 may be an LD1240 manufactured by Power Technology, Inc. of Little Rock, Ark., or another suitable laser. A portion 110A of the beam proceeds to reflector 1-8 and from there to a spatial light modulator (SLM) 1-3, which could be, for example, a Cyberdisplay 300M manufactured by Kopin Corporation of Westborough, Mass. The SLM 1-3 impresses data onto the beam 110A by spatially modulating the amplitude using a polarizer (not shown) placed after a liquid crystal device (not shown) which rotates the polarization at various locations or pixels with each pixel corresponding to some aspect of the information or data being recorded. The modulated beam, now referred to as the data beam 120, proceeds to reflector 1-23 and from there to reflector 1-6 or to one or more optional optical switches only two of which are shown as 1-7a, 1-7b. The optical switches 1-7a and 1-7b may be placed as shown to route the data beam 120 to storage locations 1-12 and 1-11 respectively in holographic storage medium 1-16. These storage locations are depicted in FIG. 1 by circles. In one embodiment, the optical switches 1-7a, and 1-7b are liquid crystal devices coupled with polarizing beamsplitters and are described in greater detail below in reference to FIG. 2. When only one storage location is present, reflector 1-6 directs beam 120 to storage location 1-10.

The other portion of the beam from beamsplitter 1-2, the reference beam 110B, proceeds to a reflector 1-22, and from there to storage medium 1-16. The data beam 120 and the reference beam 110B, having entered a particular storage location 1-10, 1-11, 1-12, interfere with the resulting electromagnetic field reacting with the storage medium to form a hologram, thus storing information.

In configuration 100, the holographic storage location 1-10, 1-11, or 1-12 into which the data is recorded corresponds to and is determined by the location of the interference pattern formed by the beam 120 and the reference beam 110B. The capacity of the data storage system 100 can be increased, for example, by placing additional storage locations and optical switches between 1-12 and 1-11 as indicated by the ellipsis, expanding the assembly as necessary. Note that absorption by the holographic storage medium 1-16 will attenuate the beam 110B such that, for storage locations further from the entrance of the medium, the beam power may have to be increased.

During a data Read cycle, the data storage system 100 reconstructs a data beam carrying the information stored in the storage medium 1-16 by directing the reference beam 110B into the storage location containing the hologram storing the desired data. The reconstructed data beam 130 emerges from the selected holographic storage locations 1-12, 1-11, and/or 1-10. From each storage location, the reconstructed data beam travels to the corresponding image detector array, or imager, which may be an OV9121 camera chip available from Omni Vision of Sunnyvale, Calif., or another suitable device. For storage location 1-12, the reconstructed beam travels to the corresponding imager 1-9; for storage location 1-11, the reconstructed beam travels to the corresponding imager 1-9′; and for storage location 1-10, the reconstructed beam travels to the corresponding imager 1-9″. The use of multiple imagers facilitates simultaneous reading of multiple storage locations with a single reference beam. During the read cycle the beam 120 may be suppressed by using SLM 1-3 to attenuate the pixels as discussed earlier.

The recording medium 1-16 can be any type of holographic recording media. Examples of organic and inorganic media types are: photopolymer, available from Aprilis of Maynard, Mass.; photorefractive crystal; photochromic material; and bacteriorhodopsin (BR) in gelatin or other hosts. These are examples only and the medium type is not meant to be so limited. Different types of media allow the characteristics of the storage system 100 to be modified for a specific application. As one example, a write-once media (WORM) such as a photopolymer can be used for archival or legal document storage. The medium 1-16 may also be removable allowing it to be used as a distribution medium for items such as music, videos, or books. In this manner, the medium 1-16 may provide similar functionality as CD, CDR-W, DVD, DVD in both writeable and rewriteable formats or hybrid forms using both a WORM and rewriteable media simultaneously.

In one embodiment, a switch 1-13 may be provided to control output of the laser 1-1. The switch 1-13 could be a liquid crystal light valve, which may use a liquid crystal rotator (as are, for example available from Meadowlark Optics of Fredrick, Colo.) and with a polarizer at the output (which are available, for example, from Moxtek, Inc. of Orem, Utah) and may control the amplitude and/or the duration of data and reference beams 120, 110B, respectively. Likewise, the SLM 1-3 can be used to block the power in the data beam 120 by setting the pixels to low or zero transmission. This may be particularly useful during read cycles.

Focusing optics may also be located within the paths of the various beams 105, 110A, 110B, 120. The focusing optics 1-14 and 1-15 could be, for example, a lens 1-14 inserted in the reconstructed data beam 130 path to focus an image onto the image detector array 1-9. This can significantly increase the number of pixels which can be stored and retrieved by reducing the effect of the diffraction spreading of the spatial beam portion emanating from each pixel of the SLM 1-3. Additionally, a field lens 1-15 may be placed near the SLM 1-3 as, for example, 1-15 and 1-15′, to direct more light into the storage media 1-10, 1-11, 1-12. As more storage locations are included in the design, the optical path length between the SLM 1-3 and the image detector array 1-9 and through storage locations further to the right of FIG. 1 increases. Additional focusing optics may be added as needed as, for example, lens 1-26. This also includes forming a lens using the input and/or output surfaces of the medium, for example, as shown at 1-30 in FIG. 1.

Additional data may be stored in a particular storage location 1-10, 1-11, 1-12 using wavelength multiplexing. This can be accomplished, for example, by thermally tuning the laser 1-1 to a frequency which does not substantially couple to any previously written patterns or holograms in the storage locations 1-10, 1-11, 1-12. Additional data beam multiplexing methods known to those skilled in the art may used, for example; shift-multiplexing, phase-code multiplexing, and peristrophic or combinations of methods. The physical position of the medium 1-16 or the optical components directing the data beam and reference beam to the medium 1-16 may be changed dynamically to implement some of the multiplexing methods.

One or more additional light sources such as light emitting diodes (LEDs) may also be used for erasing, fixing or pumping the medium at storage locations 1-10, 1-11, 1-12. Light from an LED 1-17, can be injected into the optical path of the beam 120 using beamsplitter 1-19 as shown. The beamsplitter 1-19 may be made wavelength selective by using dielectric layers so that it only substantially reflects the erase or pump wavelengths. Pumping is an exposure by light prior to writing in order to improve storage characteristics—for example, sensitivity. The added light can then be directed to a particular storage location for pumping or erasure using the optical switches 1-7a, 1-7b, and/or others if present. Fixing is an exposure which may improve the archival characteristics of the data storage. Additional light sources and beamsplitters may be added within the path of beam 120 as desired.

A Faraday rotator 1-24, such as an LD-38-R-670 available from Electro-Optics Tech, in Traverse City, Mich., may be located as shown to rotate the polarization of any laser light reflected back into the laser. This frequently can be used improve laser stability.

The configuration 100 offers the advantage that data may also be redundantly written to multiple storage locations by setting one or more switches 1-7a and 1-7b to allow the data beam 120 to enter two or more separate storage locations simultaneously. This of course will result in a reduced data beam amplitude at each storage location, so the image beam 110B should be adjusted accordingly. Since the reference beam illuminates all of the storage locations at the same time, there is no requirement for additional optics on the reference beam side to “selectively” illuminate a particular storage location. The energy, of course, must be sufficiently low enough to not expose the material. It is the interference of the reference beam and data beam that provides sufficient energy to store an image.

An important consideration for configuration 100 is that the beam 110B, as it travels through the medium 1-16, can expose portions of the storage medium which are not among those selected by the switches 1-7a, 1-7b, or others if present. For media such as bacteriorhodopsin (BR) in gelatin or other hosts, a pump beam of 570 nm may be used to increase the sensitivity of the selected storage locations relative to the unselected storage locations. This can reduce the exposure of the unselected storage locations. The storage locations are operable to store multiple images. This is facilitated by varying the wavelength of the data beam. To reconstruct the image, the beam just needs to select the wavelength corresponding to the desired image (page) stored at a selected location.

FIG. 2 is a schematic illustration of an arrangement or structure containing multiple optical switches for use in a holographic memory system. An optical switch in the arrangement or structure 200 utilizes polarization sensitive beamsplitters and liquid crystal (LC) elements. The LC, under the influence of an electric field signal, can cause the polarization of a transmitted light or beam to rotate by 90 degrees. The polarization sensitive beamsplitters will direct the transmitted beam in either of two directions dependent upon the polarization. FIG. 2 illustrates a binary tree structure containing several optical switch positions using this principle. The structure as shown in FIG. 2, may be coupled to the optical components of FIG. 1, so that the beams 2-6 and 2-8 of FIG. 1 become beam 2-6 and 2-8 of FIG. 2. Beam 2-18 enters the first LC 2-11, which sets the output to either one of two linear, orthogonal polarization states. Depending on the polarization, beamsplitter 2-1 will either transmit this beam on to reflector 2-2 or reflect it through LC 2-12 onto beamsplitter 2-16. FIG. 2 illustrates the beam 2-18 being transmitted on to reflector 2-2, which directs the beam through LC 2-12 and onto beamsplitter 2-3. LC 2-12 can be used to adjust the polarization of the beam 2-18, which strikes beamsplitter 2-3 at either one of two linear, orthogonal polarization states, as before. Depending on the polarization, beamsplitter 2-3 will either transmit the beam 2-18 through LC 2-13 and on to beamsplitter 2-17 or reflect it on to reflector 2-4. Like processes continue in order to eventually select a particular storage location such as 2-10 as illustrated in FIG. 2, which, for clarity, only depicts two others, locations 2-9 and 2-11. The storage locations 2-9, 2-10, and 2-11 may be substantially similar to storage locations 1-10, 1-11, 1-12 of FIG. 1. Only three storage locations 2-9, 2-10, 2-11 are shown here but it is understood that many may be present.

The polarization sensitive beamsplitters 2-1, 2-16, 2-3, 2-17, and others can be fabricated from subwavelength polarization sensitive gratings as are, for example available from Moxtek, Inc. of Orem, Utah. Suitable LCs are available from, for example, Meadowlark Optics of Fredrick, Colo. The spatial frequency of the lines of these gratings can be sufficiently high to suppress the first order diffracted beam. This enhancement reduces the maximum number of switches that the beams must pass through in order to be routed by arranging them into a tree like path. Though FIG. 2 illustrates a binary arrangement, the trinary or higher order arrangements can be used. Other arrangements are contemplated including using full trees, partial trees, cascaded trees and/or combinations thereof.

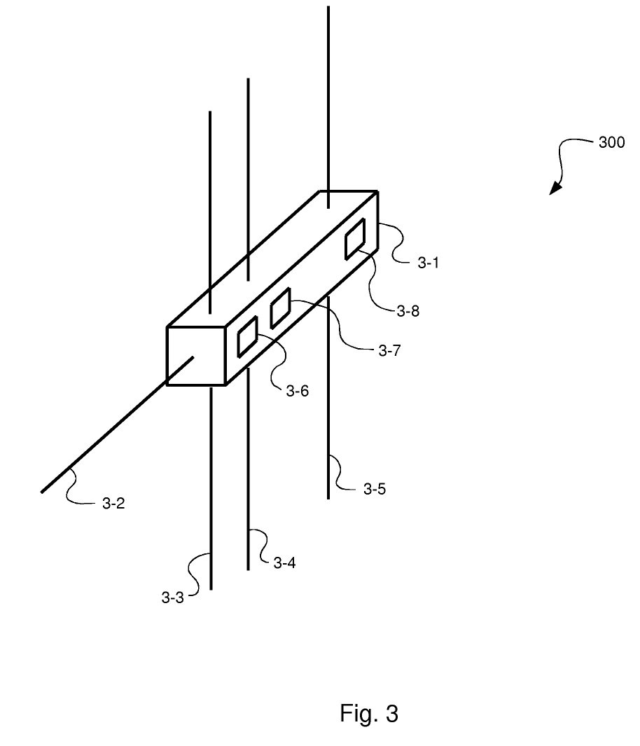

FIG. 3, is a schematic illustration of an oblique view of a storage medium 3-1 useful for holographic storage systems such as that of FIG. 1. A beam 3-2, which could be, for example beam 110B of FIG. 1 enters the medium 3-1 as shown. One or more beams 3-3, 3-4, and/or 3-5 also enter the medium as shown in FIG. 3. Beams 3-3, 3-4, and 3-5 could be beams 1-4a, 1-4b, and 1-5 of FIG. 1. FIG. 3 also schematically illustrates a light source 3-6, which could be an LED whose wavelength is chosen to erase storage locations within the medium. Alternatively, light source 3-6 could be an LED whose wavelength is chosen to pump storage locations within the medium. Light source 3-6 is positioned to erase or pump the storage location corresponding to beams 3-2 and 3-3. Light sources for pumping or erasing may be located as 3-7 and/or 3-8 also as shown in FIG. 3. Light sources of course may be located on the opposite face of the storage medium. For example, the erase light sources may be on one side of the medium and the pump light sources may be on the other side. The radiation pattern of each light source should be designed or restricted with apertures to erase or pump only a predetermined storage location within the medium 3-1. In a similar manner, depending on media type, light sources 3-6, 3-7, 3-8 may fix the media. Multiple media types may be utilized simultaneously.

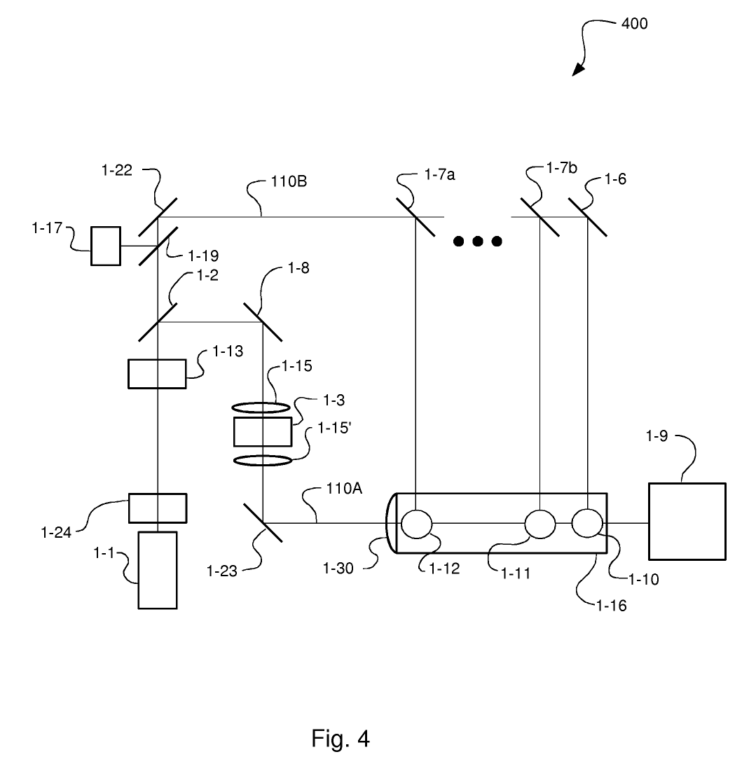

FIG. 4 schematically illustrates another configuration 400 of a holographic data storage system which differs from that of FIG. 1 in that the reference beam 110B is now switched to one or more different locations 1-12, 1-11, or 1-10 by one or more switches 1-7a or 1-7b; whereas the beam 110A from the SLM travels through all storage locations 1-12, 1-11, and 1-10 if present. An additional light source 1-17 for pumping or erasing may be located as shown in FIG. 4 with beamsplitter 1-19 directing its radiation into the path of beam 110B. Alternatively, the additional light source may be located along the medium as shown on FIG. 3.

The configuration 400 requires only one imager 1-9, relaxing the performance requirements on the switches 1-7a and 1-7b to single mode operation. This relaxed performance requirement allows the use of a wider range of optical switching and beamsteering techniques. For example, an acousticoptic deflector could be used to direct the beam to the different storage locations 1-12, 1-11, or others if present. Configuration 400 also simplifies the image reconstruction since the image focusing optics are the same for all of the storage locations 1-12, 1-11, and 1-10. Data may also be redundantly written to multiple storage locations by setting one or more switches 1-7a and 1-7b to allow the reference beam to enter two or more separate storage locations simultaneously. This of course will result in a reduced reference amplitude at each storage location, so the image beam 110A should be adjusted accordingly. In configuration 600 these switches operate only upon the reference beam which can be essentially a plane wave.

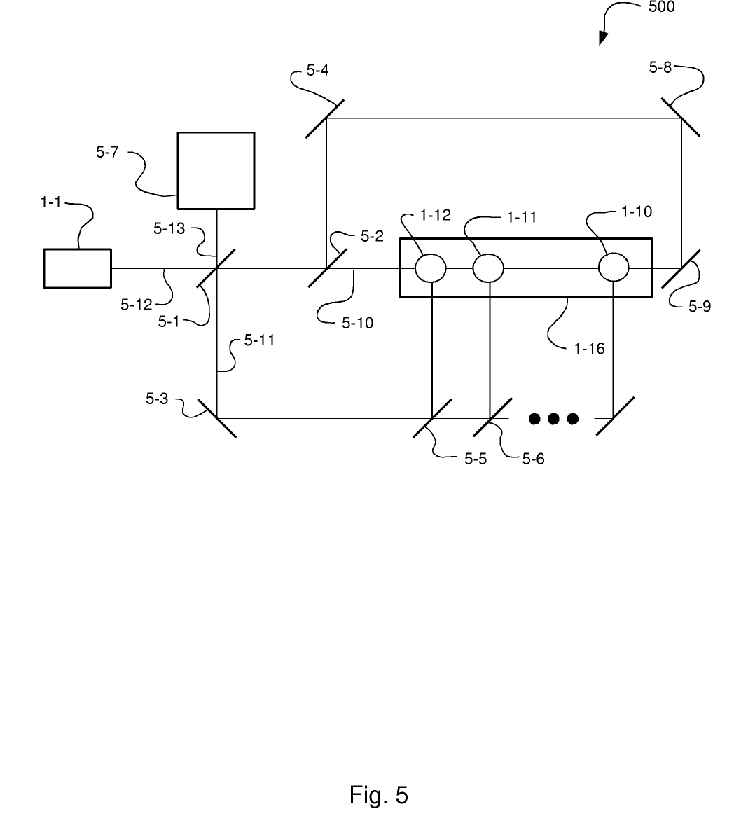

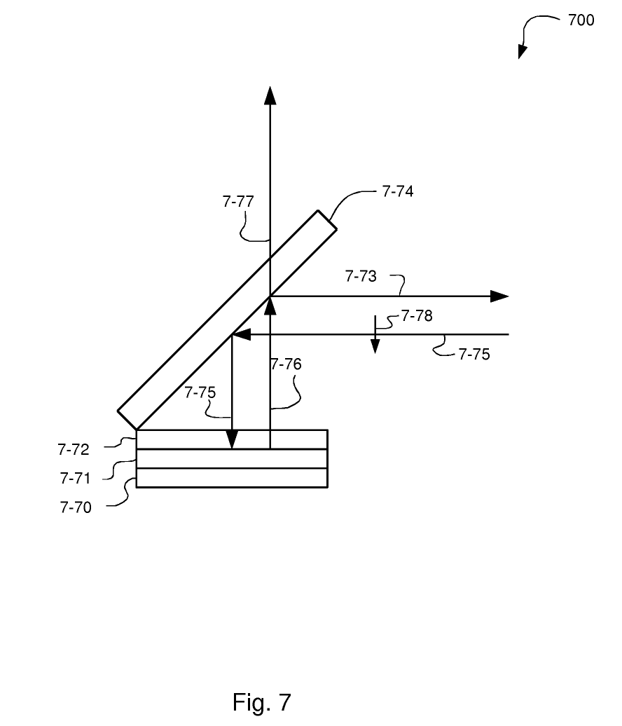

FIG. 5 schematically illustrates another configuration 500 of a holographic data storage system, which is termed conjugate. During a Write cycle, laser beam 5-12 from laser 1-1 encounters a switch 5-1, which transmits a portion, termed the reference beam 5-10, through optical switch 5-2 and into the storage medium 1-16. A portion 5-13 of the beam 5-12 reflected by switch 5-1 travels to the SLM/imager 5-7, which reflects a portion, termed the data beam 5-11, upon which has been impressed the data to be stored as described below with reference to FIG. 7. A portion of the data beam 5-11 travels through the switchable beamsplitter 5-1, on to reflector 5-3, then on to optical switches, like 5-5 and 5-6, which direct the light to a storage location 1-12, 1-11, or others if present. The reference 5-10 and the data 5-11 beams interfere within one or more storage locations 1-12, 1-11, or others if present, in medium 1-16 and produce a hologram.

During the Read cycle, the beam from laser 1-1 again encounters switch 5-1, which is now adjusted to transmit essentially all of the beam on to optical switch 5-2, which is adjusted to reflect it to mirror 5-4. From mirror 5-4 the beam travels to mirror 5-8 then to mirror 5-9 and into medium 1-16 essentially antiparallel to the reference beam 5-10 mentioned above. Upon entering a storage location bearing a hologram constructed earlier with essentially the same laser wavelength, a reconstructed, backward traveling data beam emerges from the medium 1-16 and follows the path back to SLM/imager 5-7 originally traveled by data beam 5-11.

In addition to the known advantages of a conjugate holographics storage system, configuration 500 affords the ability to simultaneously write data to two or more storage locations.

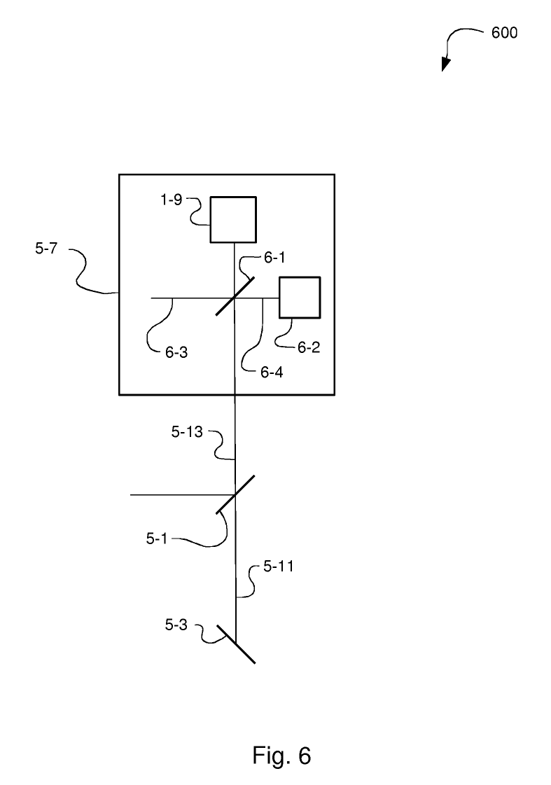

FIG. 6 schematically illustrates a configuration 600 of the SLM/imager 5-7. During a write cycle in this configuration, the portion 5-13 of laser beam 5-12 strikes polarization sensitive beamplitter 6-1, which reflects at least a portion 6-4 having a particular polarization state onto reflective SLM 6-2, which could be a model LDP-0983-HS1 reflective spatial light modulator available from Displaytech, Inc. of Longmont, Colo. USA. The SLM 6-2 alters the polarization state of the beam portion 6-4 on a pixel by pixel basis impressing data onto the portion. The altered beam portion is reflected back to polarization sensitive beamplitter 6-1, which reflects at least a portion having the particular polarization state onto switch 5-1. Those pixels whose polarization state had been altered by SLM 6-2 are not reflected by polarization sensitive beamplitter 6-1 and form beam 6-3 which may be absorbed or directed out of the Holographic recording system.

During a read cycle the reconstructed, backward traveling data beam emerging following the path back to SLM/imager 5-7, as mentioned in connection with FIG. 5, encounters polarization sensitive beamsplitter 6-1, which transmits at least a portion 6-4 onto imager 1-9.

Alternatively, polarization sensitive beamsplitter 6-1 may be instead an optical switch as describe above with reference to FIG. 2.

FIG. 7 is a schematic illustration of a combined spatial light modulator (SLM) and imager. A polarization sensitive beamsplitter 7-74 reflects a particular polarization component, designated generally by 7-78, of incoming beam 7-75. The beam proceeds down through SLM 7-72 which adjusts the polarization at the various pixel locations in a manner corresponding to the data to be stored. A portion of the light from each pixel will be reflected by polarization beamsplitter 7-71 as determined by its adjusted polarization. These reflected portions travel back as depicted by arrow 7-76, which is shown displaced to the right for clarity, and proceed through SLM 7-72 having their polarizations adjusted yet a second time. From here, these reflected portions travel back to beamsplitter 7-74, which reflects a portion 7-73 of each pixel again in accordance with its adjusted polarization. Aside from absorption, the remainder 7-77 of the light in each pixel travels through beamsplitter 7-74.

As one example of the operation of this device, assume an SLM pixel is adjusted to be a ½ waveplate and oriented so that it rotates the polarization of a spatial portion of light from beam 7-75 by 90 degrees. This light strikes beamsplitter 7-71, which is oriented to reflect it back through the SLM, which again rotates its polarization by 90 degrees so that it is again reflected by beamsplitter 7-74 as depicted by beam 7-73. If, however, an SLM pixel is adjusted to be a zero waveplate, i.e. causes no differential retardance, then light from beam 7-75 upon passing through the SLM would not be rotated and therefore would pass through beamsplitter 7-71 and onto image detector array 7-70 and would be generally absorbed. Thus, data can be impressed upon beam 7-73 during a write cycle. During a read cycle, beam 7-75 would be the reconstructed data beam. Setting all of the SLM pixels to zero retardance would generally allow the beam to strike the image detector array and be absorbed and converted to an electrical signal. This integrated SLM/Imager reduces the number of optoelectronic components and thereby the optoelectronic overhead and can simplify registration of the SLM and imager pixels. A simplified method of accessing media regions for holographic data storage which provides a very small form factor.

Greatly reduce the size of a Holographic Storage system by utilizing switched, guide beam routing and wavelength multiplexing. The resulting small size enables a number of uses. These uses bring high capacity fast access mass memory into small systems or into lower levels of a computer memory hierarchy.

It will be appreciated by those skilled in the art having the benefit of this disclosure that this invention provides a holographic data storage system. The data storage system includes a holographic data storage media adapted to receive a data beam and a reference beam and store a data pattern associated with the data beam. The data pattern is expressed by a holographic representation corresponding to data elements of the data beam. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A holographic memory device, said holographic memory device comprising:
a laser for emitting a laser light beam;
a beam splitter positioned to receive said laser light beam from said laser and separate said laser light beam into a reference beam and a data beam;
a Spatial Light Modulator (SLM) for impressing data onto said data beam;
a holographic storage medium, wherein said storage medium further comprises a plurality of storage locations;
a first beam reflector, positioned to route said reference beam from said beam splitter into said plurality of storage locations of said storage medium;
a second beam reflector positioned to route said data beam from said beam splitter to said SLM;
a third beam reflector;
a plurality of optical switches;
a fourth beam reflector;
a plurality of image detectors; and
wherein said third beam reflector is positioned to reflect said data beam received from said SLM into said plurality of optical switches, each of said plurality of optical switches adapted to route a portion of said data beam into at least one of said plurality of storage locations, said fourth beam reflector positioned to route a remaining portion of said data beam into at least one of said storage locations, and wherein said plurality of image detectors are positioned to receive at least one reconstructed data beam from at least one of said storage locations of said storage medium.

2. The holographic memory device of claim 1, wherein said plurality of optical switches further comprises a plurality of polarization sensitive beam splitters and a plurality of Liquid Crystal (LC) elements.

3. The holographic memory device of claim 2, wherein said plurality of polarization beam splitters are fabricated from subwavelength polarization sensitive gratings with a high spatial frequency of a plurality of lines of said gratings.

4. The holographic memory device of claim 1, wherein said storage medium is one of a photopolymer, photorefractive crystal, photochromic material, and bacheriorhodopsin in gelatin.

5. The holographic memory device of claim 1, wherein said storage medium further comprises a number of light sources positioned to erase said plurality of storage locations.

6. The holographic memory device of claim 1, wherein said storage medium further comprises a number of light sources positioned to pump said plurality of storage locations.

7. The holographic memory device of claim 1, said holographic memory device further comprising a plurality of focusing optics.

8. The holographic memory device of claim 7, wherein one of said plurality of focusing optics is positioned adjacent to said SLM.

9. The holographic memory device of claim 7, wherein one of said plurality of focusing optics further comprises an input surface of said storage medium.

10. The holographic memory device of claim 7, wherein at least one of said plurality of focusing optics is positioned between at least one of said storage locations and at least one of said plurality of image detectors.

11. A holographic memory device, said holographic memory device comprising:
a laser for emitting a laser light beam;
a beam splitter, wherein said beam splitter is positioned to separate said laser light beam into a reference beam and a data beam;
a Spatial Light Modulator (SLM) for impressing data onto said data beam;
a holographic storage medium, wherein said storage medium is further comprised of a plurality of storage locations;
a plurality of optical switches;
a first beam reflector positioned to route said reference beam into said plurality of optical switches;
a second beam reflector positioned to route said data beam from said beam splitter to said SLM;
a third beam reflector positioned to route said data beam received from said SLM into said plurality of storage locations of said holographic storage medium;
a fourth beam reflector;
an image detector; and
wherein each of said plurality of optical switches is adapted to route at least a portion of said data beam into at least one of said plurality of storage locations, said fourth beam reflector positioned to route a remaining portion of said data beam into at least one of said storage locations, and wherein said image detector is positioned to receive a reconstructed data beam from said storage medium.

12. The holographic memory device of claim 11, wherein said plurality of optical switches further comprises a plurality of polarization sensitive beam splitters and a plurality of Liquid Crystal (LC) elements.

13. The holographic memory device of claim 12, wherein said plurality of polarization beam splitters are fabricated from subwavelength polarization sensitive gratings with a high spatial frequency of a plurality of lines of said gratings.

14. The holographic memory device of claim 1, wherein said storage medium is one of a photopolymer, photorefractive crystal, photochromic material, and bacheriorhodopsin in gelatin.

15. The holographic memory device of claim 11, wherein said storage medium further comprises a number of light sources positioned to erase said plurality of storage locations.

16. The holographic memory device of claim 11, wherein said storage medium further comprises a number of light sources positioned to pump said plurality of storage locations.

17. The holographic memory device of claim 11, said holographic memory device further comprises a plurality of focusing optics.

18. The holographic memory device of claim 17, wherein one of said plurality of focusing optics is positioned adjacent to said SLM.

19. The holographic memory device of claim 17, wherein one of said plurality of focusing optics further comprises an input surface of said storage medium.

20. A conjugate holographic memory device, said conjugate holographic memory device comprising:
a laser for emitting a laser light beam;
a Spatial Light Modulator (SLM)/Imager for impressing data onto said data beam and reflecting said data impressed data beam;
a holographic storage medium, wherein said storage medium is further comprised of a plurality of storage locations;
a switchable beam splitter positioned to receive said laser light beam from said laser, wherein said beam splitter separates said laser light beam into a reference beam and a data beam, transmits said reference beam to a first optical switch, reflects said data beam to said SLM, receives said data impressed data beam from said SLM/Imager and transmits said data impressed data beam to a first reflector;
said first reflector positioned to route said data impressed data beam to a plurality of optical switches;
said plurality of optical switches adapted to route at least a portion of said data impressed data beam into at least one of a said plurality of storage locations; and
a second reflector positioned to route a remaining portion of said data impressed data beam into at least one of said plurality of storage locations.

21. The conjugate holographic memory device of claim 20, wherein said SLM/Imager further comprises:
a polarization beam splitter;
a reflective SLM;
an image detector; and
wherein said polarization beam splitter is positioned to reflect at least a portion of said data beam onto said reflective SLM, receive an altered polarization of said data beam from said reflective SLM, and transmit a reconstructed data beam to said image detector.

22. The conjugate holographic memory device of claim 20, wherein said plurality of optical switches further comprises a plurality of polarization sensitive beam splitters and a plurality of Liquid Crystal (LC) elements.

23. The conjugate holographic memory device of claim 22, wherein said plurality of polarization beam splitters are fabricated from subwavelength polarization sensitive gratings with a high spatial frequency of a plurality of lines of said gratings.

24. The conjugate holographic memory device of claim 20, wherein said storage medium is one of a photopolymer, photorefractive crystal, photochromic material, and bacheriorhodopsin in gelatin.

25. The conjugate holographic memory device of claim 20, wherein said storage medium further comprises a number of light sources positioned to erase said plurality of storage locations.

26. The conjugate holographic memory device of claim 20, wherein said storage medium further comprises a number of light sources positioned to pump said plurality of storage locations.

27. The conjugate holographic memory device of claim 20, wherein said SLM/Imager further comprises:
a first polarization beam splitter;
a SLM to adjust a polarization of said data beam;
a second polarization beam splitter positioned between said SLM and an image detector array;
said image detector array positioned adjacent to said second polarization beam splitter; and
wherein said first polarization beam splitter is positioned to reflect said data beam to said SLM, said SLM adapted to adjust said polarization of said data beam such that said adjusted data beam is reflected by said second polarization beam splitter to said first polarization beam splitter.

28. A method of storing holographic data, the method comprising:
transmitting, from a laser, a laser light beam;
splitting the laser light beam into a reference beam and a data beam;
transmitting the reference beam through a first reflector to a plurality of storage locations within a holographic storage medium;
routing the data beam through a second reflector to a Spatial Light Modulator (SLM);
impressing data onto the data beam by the SLM;
transmitting the data beam from the SLM through a third reflector to a plurality of optical switches;
forming a plurality of data beams by:
routing, by at least one of the plurality of optical switches, at least a portion of the data beam into at least one of the plurality of storage locations,
transmitting a remaining portion of the data beam through the plurality of optical switches, and
routing, by a fourth reflector, a final remaining portion of the data beam to at least one of the plurality of storage locations;
combining at least one of the plurality of data beams and the reference beam in at least one of the plurality of storage locations;
forming a hologram from the combined reference beam and data beam; and
storing the hologram in at least one of the plurality of storage locations.

29. The method of claim 28, the method further comprising the steps of:
directing the reference beam into the plurality of storage locations;
suppressing the data beam by the SLM; and
receiving, by at least one of a plurality of image detectors, from the plurality of storage locations, a reconstructed data beam.

30. The method of claim 28, the method further comprising the steps of focusing the data beam through a focus lens positioned adjacent to the SLM.

31. The method of claim 28, wherein the step of routing, by at least one of the plurality of optical switches, at least a portion of the data beam into at least one of the plurality of storage locations, further comprises setting a number of the plurality of optical switches to allow the data beam to enter a number of the plurality of storage locations.

32. A method of storing holographic data, the method comprising:
transmitting, from a laser, a laser light beam;
splitting the laser light beam into a reference beam and a data beam;
transmitting the reference beam through a first reflector to a plurality of optical switches;
routing the data beam through a second reflector to a Spatial Light Modulator (SLM);
impressing data onto the data beam by the SLM;
transmitting the data impressed data beam from the SLM through a third reflector to a plurality of storage locations within a holographic storage medium;
splitting, by at least one of the plurality of optical switches, the reference beam into a plurality of reference beams;
routing, by at least one of the plurality of optical switches, at least one of the plurality reference beams into at least one of the plurality of storage locations;
transmitting a remaining portion of the reference beam through a fourth reflector to at least one of the plurality of storage locations;
combining the data impressed data beam and at least one of the plurality of reference beams in at least one of the plurality of storage locations; and
forming a hologram from the combined plurality of reference beams and data impressed data beam; and
storing the hologram in at least one of the plurality of storage locations.

33. A method of storing holographic data, the method comprising:
transmitting, from a laser, a laser light beam;
splitting, by a switchable beam splitter, the laser light beam into a reference beam and a data beam;
transmitting the reference beam through a first reflector through a front side of storage medium into a plurality of storage locations within the storage medium;
routing the data beam to a combination Spatial Light Modulator (SLM)/Imager;
impressing data onto the data beam by the SLM/Imager;
reflecting the data impressed data beam from the SLM back through the switchable beam splitter;
transmitting, by the switchable beam splitter, the data impressed data beam through a reflector to a plurality of optical switches;
forming a plurality of data impressed data beams by:
routing, by at least one of the plurality of optical switches, at least a portion of the data impressed data beam into at least one of the plurality of storage locations,
transmitting a remaining portion of the data impressed data beam through the plurality of optical switches, and
routing, by a fourth reflector, a final remaining portion of the data impressed data beam to at least one of the plurality of storage locations;
combining at least one of the plurality of data impressed data beams and the reference beam in at least one of the plurality of storage locations; and
forming a hologram from the combined reference beam and data impressed data beam; and
storing the hologram in at least one of the plurality of storage locations.

34. The method of claim 33, the method further comprising the steps of:
directing the reference beam through a plurality of reflectors into a rear side of the storage medium into the plurality of storage locations;
suppressing the data beam by the SLM; and
emitting, by the storage medium, a reconstructed data beam;
routing, by the switchable beam splitter, the reconstructed beam to the SLM/Imager; and
receiving, by the SLM/Imager, the reconstructed data beam.

35. A method for storing data in a holographic memory storage medium′ comprising the steps of:
defining a plurality of storage locations in the storage medium along a common axis;
directing a first beam of coherent light along the common axis through the storage medium such that it radiates substantially all of the storage locations along the common axis;
directing a second beam of coherent light to a beam steering device;
steering the second beam of coherent light to intersect with the first coherent beam of lights in at least one or more of the storage locations; and
impressing data as a pixilated image on one of the first or second beams of coherent light to create a holographic image at the intersection of the first and second coherent beams of light at in the steered to at least one or more of the storage locations.
